(19) United States
(12) Patent Application Publication
(10) Pub. No.: US 2005/0055262 A1
(43) Pub. Date: Mar. 10, 2005

(54) System and a method for distributing assignments and receiving report data

(76) Inventor: Keld Florczak, Horsens (DK)

Correspondence Address: CANTOR COLBURN, LLP, 55 GRIFFIN ROAD SOUTH, BLOOMFIELD, CT, 06002, US

(21) Appl. No.: 10/493,299

(22) PCT Filed: Oct. 24, 2002
(86) PCT No.: PCT/DK02/00709

(30) Foreign Application Priority Data
Oct. 26, 2001 (DK) PA200101575

(51) Int. Cl. G06F 17/60

(52) U.S. Cl. 705/9; 705/10

(57) ABSTRACT

A system as well as a method is disclosed for distributing taks assignements from a central computer to a plurality of portable units and receiving report data describing the outcome of the assignment, wherein detailed, computer-analysable outcome data are generated in case an assignment is not completed. The system comprises report generation means that from the given mobile unit requires user input data indicating the selection of either a completion outcome, or one or more non-completion reasons from a plurality of predefined non-completion reasons, in order to generate the outcome data with information about the user input. Furthermore is described a computer-based method of quantitative evaluation of resource efficiency for a plurality of human resources attending a plurality of assignments.

The present invention relates to a system as well as a method for distributing task assignments from a central computer to a plurality of portable units and receiving report data describing the outcome of the assignment, wherein detailed, computer-analysable outcome data are generated in case an assignment is not completed.

The present invention further relates to a computer-based method of quantitative evaluation of resource efficiency for a plurality of human resources attending a plurality of assignments.

### BACKGROUND

The background for the present invention comes from a wide range of businesses performing service or service related activities, in which a plurality of human resource units, typically one or two persons, physically move from one physical location to another to perform one assignment at each location. The service may be routine inspection, maintenance and repair of equipment, either within the business itself as an internal function or externally to a plurality of costumers. The efficiency with which the assignments are completed may readily be measured at an overall level as e.g. an average value of the number of completed assignments per resource unit per day. However, in order to be able to improve the efficiency of the organisation, it is important reliably and quantitatively to be able to identify the obstacles to a high efficiency. In particular, the reasons for non-completion of some of the assignments may in certain fields of business be most important, because a non-completed assignment normally requires a second visit of a resource unit to the particular location, thus requiring additional transport time and reducing the overall efficiency.

The provision of effective efforts to improve the efficiency is conditioned by the level of knowledge about the obstacles that prevent the business from obtaining a high efficiency. The use of assignment papers of each assignment, comprising a section for writing reasons for delays and non-completion of the assignment has proven to produce only a low rate of data collection with respect to this aspect, as the persons using the assignment sheets have a tendency to only fill out the parts most essential to themselves: the number of working hours spent and optionally the amount of spare parts used, etc.

In particular for quantitative evaluation of resource efficiency for a plurality of humans attending a plurality of assignments, it is important to obtain a high data rate of a standardized form, so that a computer-based evaluation system can be employed with the object of improving the efficiency of the organisation of the work.

Electronic systems for management of assignments to a plurality of users each having a portable unit is well known in the prior art. EP-A-0 777 199 to Neon Industrie Urbane Einrichtungen GmbH discloses a system for managing work assignments to be carried out on poster holders. A central computer transmits information concerning work to be carried out and/or a type of job and/or a required time for the completion of the job, to a mobile computer unit. The poster holder and/or the poster are/is identified by the mobile computer unit and a time marker establishes the beginning of the work period. Work specific information, such as which spare parts are needed to repair the poster, is read into the mobile computer and is transmitted to the central computer. The central computer may re-plan the scheduling and distribution of work assignments continuously by means of an optimising routine.

WO-A-00/4 1104 to CT Motion Ltd. discloses a system for managing mobile workers in order to improve control over the mobile workers, increasing the worker's productivity through dynamic workload allocation and job assignment. The system defines and communicates a current task assignment schedule to a worker, automatically monitor the worker's location during the current schedule, correlates the monitored location with the current schedule, and selects and reports aspects of the correlation.

WO-A-00/62222 to Syvox Corp. discloses a system for managing mobile workers, in which speech recognition is used, and DE-A-197 11 907 to Siemens AG discloses a system in which the position of each mobile unit is determined from the position relative to a plurality of transceiver stations constituting a wireless data communication network.

The features of the above-discussed systems for managing mobile workers may be implemented in the system of the present invention, but the problem with these known systems is similar to the problem with the use of assignment papers: they produce only a low rate of data collection with respect to reasons for delays and non-completion of the assignments.

It is therefore an object of the present invention to provide a system for management of assignments to a plurality of users each having a portable unit, which will improve the rate of data collection with respect to reasons for non-completion of the assignments.

Such system is provided by means of the present invention, which in a broadest aspect relates to a system comprising
a central computer having at least one central processing unit and data storage means associated therewith,
a plurality of mobile units, such as portable, handheld computers, having data input means, e.g. one or more keys, a full keyboard or a touch-sensitive display screen and/or a microphone, for inputting data from a user of the mobile unit, and means for wireless data communication connection with the central computer,
each mobile unit comprising means to receive data pertaining to assignments from the central computer and transmitting outcome data pertaining to identified assignments to the central computer by means of said data communication connection,
wherein the system comprises report generation means being adapted to require user input from the data input means of the given mobile unit, indicating the selection of a completion outcome, or
one or more non-completion reasons from a plurality of predefined non-completion reasons,
in order to generate the outcome data, said outcome data comprising information indicating said user input.

The wireless data communication connection may be established via a communication network dedicated to the use, or via a public communication network, e.g. for cellular telephone communication. A number of possibilities are discussed in the aforementioned WO-A-00/41104. It is preferred to employ package based communication standards such as General Packet Radio Service (GPRS) because an on-line communication between the central computer and each mobile unit by use of such standards can be maintained inexpensively without constantly occupying a connection line of the communication network.

By conditioning the generation of completion data by a user input indicating either a completion outcome, or one or more non-completion reasons selected from a list containing a plurality of predefined non-completion reasons, a very high rate of data collection with respect to reasons for non-completion of the assignments is obtained, because the assignment otherwise would appear to be non-concluded.

It is preferred that each mobile unit comprises data output means for outputting data to a user, e.g. a display screen for visual output and/or a loudspeaker, and wherein said report generation means comprises presenting means for presenting output data representing a plurality of predefined non-completion reasons to the user by means of the data output means of the given mobile unit. In a particular embodiment, a list of standard non-completion reasons is presented on a touch-sensitive display screen of the portable unit and the user input is provided by the user touching the screen at the position of the non-completion reason to be selected.

The central computer may comprise means for transmitting a prioritised list of a plurality of assignments to each mobile unit, so that the user may be able to select one of the assignments on the list as the next assignment. In particular, each mobile unit may comprise means for activation of an assignment from the list of assignments by selecting the assignment by means of the data input means of the mobile unit, and the generation of completion data of an assignment includes the step of terminating the activation of said assignment, wherein the activation of an assignment from the list only is possible to perform if all previous activations of assignments of the mobile unit are terminated. Thereby, it is supported that user input for generating completion data is given, and a higher data rate may consequently be achieved. However, it may within this feature be arranged that an active assignment may be temporarily halted or suspended while an urgent task is performed and reported, e.g. as exemplified below in the description of an embodiment of the invention in which a “panic” button may be activated.

The activation of an assignment may imply that one or more actions relating to the assignment is taken, such as measurement of time used for the assignment, measurement of distance travelled for attending the assignment, issuance of a signal to the central computer indicating that the assignment is activated, and/or details about the assignment is displayed to the user, etc.

The system may be integrating with the inventory and/or the billing system of the company by providing each mobile unit with means for registration of resource consumption and the report generation means being adapted to include resource consumption data in the generated outcome data. The resource consumption that is registered may preferably comprise time consumption, but e.g. consumption of spare parts and other items and/or distance travelled for attending the assignment could additionally or alternatively be included in the resource consumption.

It is furthermore advantageous if each mobile unit comprises position means, e.g. a satellite signal based system such as Global Position System (GPS), for determining its current position and generating an output accordingly. The position output may be used to compute the distance travelled for attending a given assignment and/or be transmitted to the central computer or another central unit associated with the system, for providing an overview of the location of the individual units, e.g. for selecting a unit for handling an urgent assignment. An alternative type of positioning means is means for determining the current position of each mobile unit from a plurality of transceiver stations constituting a wireless data communication network by means of which said wireless data communication connection with the central computer. This latter type of positioning means may be situated in each mobile unit based on signals received by the mobile unit from one or more such transceiver stations, or the positioning means may be stationary and base the positioning determination on signals received by one or more of the transceiver stations from each of the mobile units.

It is furthermore an advantage that the central computer comprises means for accumulating the outcome data by storing the outcome data in said data storage means, and means for processing the accumulated outcome data so as to calculate statistical properties thereof.

Furthermore, the present invention relates to a method of operating a system for distributing assignments and collecting completion data pertaining to the assignments, which method comprises the steps of
communicating each assignment from a central computer to one of a plurality of mobile units by means of a wireless data communication connection, and
generating outcome data pertaining to an identified assignment after receiving either a user input at the mobile unit, indicating the selection of a completion outcome, or a user input indicating the selection of one or more non-completion reasons from a plurality of predefined non-completion reasons, the outcome data comprising information indicating said user input.

In order to facilitate the selection of one or more non-completion reasons, it is advantageous that a list of predefined non-completion reasons is presented to the user by means of data output means of the mobile unit.

The method may furthermore comprise the step of transmitting a prioritised list of a plurality of assignments from the central computer to each of the mobile units. In particular, the method may further comprise the steps of
activating an assignment from the list of assignments of a mobile unit by means of the data input means of the mobile unit, and
terminating the activation of said assignment concurrent with the generation of completion data of the activated assignment,
wherein the activation of an assignment from the list is only possible if all previous activations of assignments of the mobile unit are terminated.

Likewise, the method may additionally or alternatively furthermore comprise the steps of
registration of resource consumption data associated with a given assignment, and
including the registered resource consumption data in the generated outcome data generated by means of the report generation means. In particular, the resource consumption data may comprises time consumption data. Even more preferred, the time consumption data may be generated from a starting time registered at the activation of the given assignment and an ending time registered at the termination of the activation of the given assignment.

The method may also comprise the steps of
registration of the current position of a given mobile unit, and
including the registered position data in the generated outcome data generated by means of the report generation means. In particular, the position data may be generated at the activation of the given assignment and at the termination of the activation of the given assignment.

As a consequence of the invention of the above-disclosed system and method for obtaining a sufficient high rate of data collection with respect to reasons for non-completion of the assignments in a form that is suited for being utilized by a computer as input data, it has become much more relevant to develop a computer-based method for evaluating such results.

Thus, the present invention relates in a particular aspect thereof to a computer-based method of quantitative evaluation of resource efficiency for a plurality of human resources attending a plurality of assignments. This method comprises the steps of
collecting outcome data pertaining to each assignment, wherein each outcome data comprises an indication of either a completion outcome data or of the selection of one or more non-completion reasons from a common predefined list of non-completion reasons,
storing said outcome data in data storage means associated with a computer having a central processing unit,
calculating the total number of assignments with an outcome data and the number of assignments with a completion outcome data,
calculating for each of said predefined non-completion reasons the number of assignments with the specific reason selected, and
storing the calculated numbers in a result file defined in said data storage means.

The outcome data may preferably be collected by means of the system and/or method disclosed above. According to the present method, the collected outcome data are organised in a systematic manner that allows for the subsequent data reduction procedure that ends up with providing a series of highly informative key data that are stored for subsequent use.

According to a particular embodiment of this aspect, the method may further comprise the steps of
calculating a resource utilization index as the ratio between the number of assignments with a completion outcome data and the product of a predefined nominal production and a predefined available time, and
storing the calculated resource utilization index in said result file.

The resource utilization index is important to obtain when reducing the collected data, because it is a dimensionless index for the actual utilization of the human resources as compared to the highest theoretical utilization. The index is so important that the collection of data and calculation of the resource utilization index in itself constitutes an invention.

Thus, another particular aspect of the present invention relates to a computer-based method of quantitative evaluation of resource efficiency for a plurality of human resources attending a plurality of assignments, comprising the steps of
collecting outcome data pertaining to each assignment, wherein each outcome data may comprise an indication of a completion outcome data,
storing said outcome data in data storage means associated with a computer having a central processing unit,
calculating the total number of assignments with an outcome data and the number of assignments with a completion outcome data,
calculating a resource utilization index as the ratio between the number of assignments with a completion outcome data and the product of a predefined nominal production and a predefined available time, and
storing the calculated numbers in a result file defined in said data storage means.

For both the above-mentioned aspects, the nominal production may be predefined by performing the steps of
collecting time consumption data pertaining to each assignment,
storing said time consumption data in said data storage means,
calculating the nominal production as the inverse of the average time consumption of assignments with a completion outcome data, and
storing said nominal production in said result file. Alternatively, the nominal production may be defined manually or by another model and be entered into the system as a constant value.

A further important index that may be calculated in accordance with the two latter aspects of the present invention is the error index, which also could be named the non-error index, a dimensionless number indicating the ratio between the number of completed assignments without errors and the number of completed assignments. Thus, the methods may further comprise the generation of an error index by the steps of
collecting error data indicating defective or imperfect condition of identified assignments with a completion outcome data,
storing said error data in said data storage means,
calculating the error index as the ratio between the number of assignments with a completion outcome data minus the number of assignments indicated in the error data, and the number of assignments with a completion outcome, and
storing said error index in said result file.

An overall resource efficiency index may be calculated as the product of the resource utilization index and the error index. The overall resource efficiency index may furthermore be multiplied by an accessibility index, being the ratio between the actual hours the human resources are accessible and the number of hours they are employed. The difference is due to internal meetings, courses, internal transport, etc.

The present invention also relates to a computer program product stored in a machine-readable form, such as on a data carrier, that when installed on a computer, may enable the computer to execute one or both of the methods discussed above.

### BRIEF DESCRIPTION OF THE FIGURES

A system being an embodiment of the present invention is disclosed below with reference to the enclosed figures, of which

FIG. 1 shows an overview of the system connected with an existing computer platform,

FIG. 2 shows the interaction between the distribution platform and the portlets on the portable units,

FIG. 3 shows the connection and interaction of the system with the existing platform,

FIG. 4 illustrates the workflow of the use of the portable unit, and

FIG. 5 demonstrates the reporting of a concluded job assignment from a portable unit.

### DETAILED DESCRIPTION OF AN EMBODIMENT OF THE PRESENT INVENTION

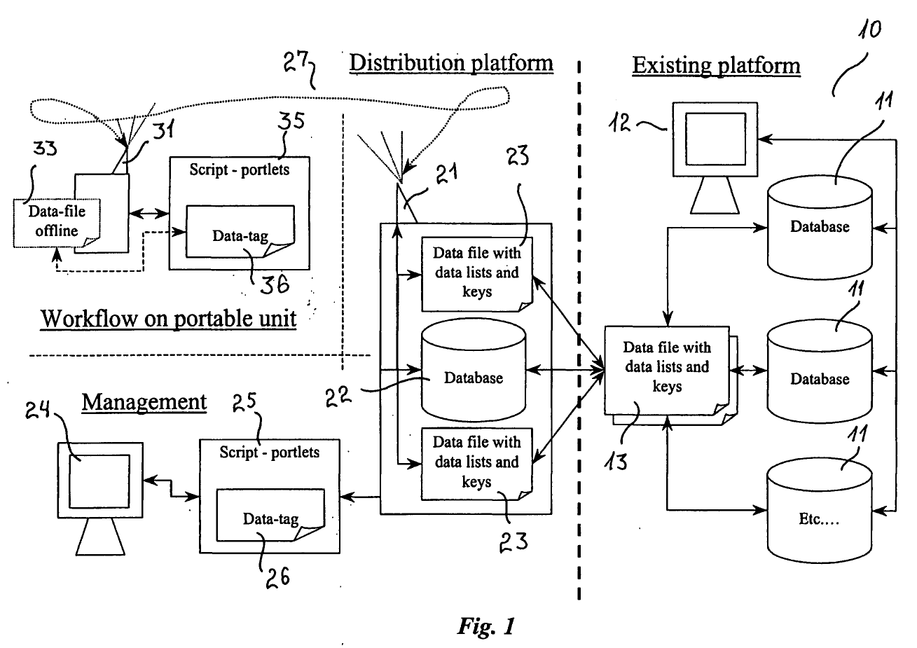

FIG. 1 shows an embodiment of the present invention connected to the existing computer platform 10 of the customer, the platform 10 comprising one or more computer systems 11 in data communication connection with at least one terminal 12 from which the platform 10 may be controlled. Data files 13 contain data lists and keys that are exchanged with the distribution platform 20 of the embodiment of the present invention, which comprises a separate database 22 comprising data files 23 containing data lists and keys which are used to form the description of job assignments to be distributed. The management part of the distribution platform 20 has a script portlet 25 comprising a plurality of data tags 26, similar to the script portlet 35 of the portable terminals 30. The data tags 26 associate pre-selected data of one or more data files 23 with a particular function or type of information that is required to form the list of assignments. The management, i.e. monitoring and control of the work processes of the distribution platform 20, such as distribution of job assignments to the various portable terminals 30, the change of order of assignments, etc., may be performed via at least one terminal 24. Data communication means 21 transfers a pre-selected group of data from one or more of the data files 23 to one of a plurality of portable terminals 30 comprising wireless data communication means 31. The wireless data communication connection 27 between the data communication means 21, 31 may be a direct wireless transmission, e.g. if radio communication is used, or it may be a combination of wireless data transmission and data transmission by electrical or optical wire on a private or public data communication network. The content of the transmitted pre-selected data from the data files file 23 is used to form a local data file 33, which after the transmission can be used by the terminal 30 to reconstruct the script portlet 35, also when the portable terminal 30 is offline for a shorter or longer period of time. Thereby, an operational state of the portable units 30 is ensured even if the data communication connection 27 is disconnected for a period of time or has a time delay. A real-time connection between the portable units 30 and the distribution platform 20 is therefore not required.

Thus, FIG. 1 shows an overview of a general distribution platform for the distribution of data flow between a central computer system 10, a dedicated distribution platform 20 and a plurality of mobile terminals 30.

The data files 23 of the distribution system 20 contain a plurality of data collected from the database 22 and the data files 23 are continuously updated with the data of the database 22. The data in the data files 23 may additionally or alternatively comprise data tags that connect or point directly to data in the database 22. Likewise, the data in the database 22 are continuously updated with the data of the databases 11 of the existing computer platform 10 and/or comprise data tags that connect or point directly to data in the databases 11. The existing computer platform 10 may comprise a plurality of integrated and stand-alone systems, being static or dynamic. By updating the database 22 of the distribution system 20 from these databases 11, a buffer of the most current valid data is provided for the data files 23 that are employed to pre-select data from for transmission to the portable units 30.

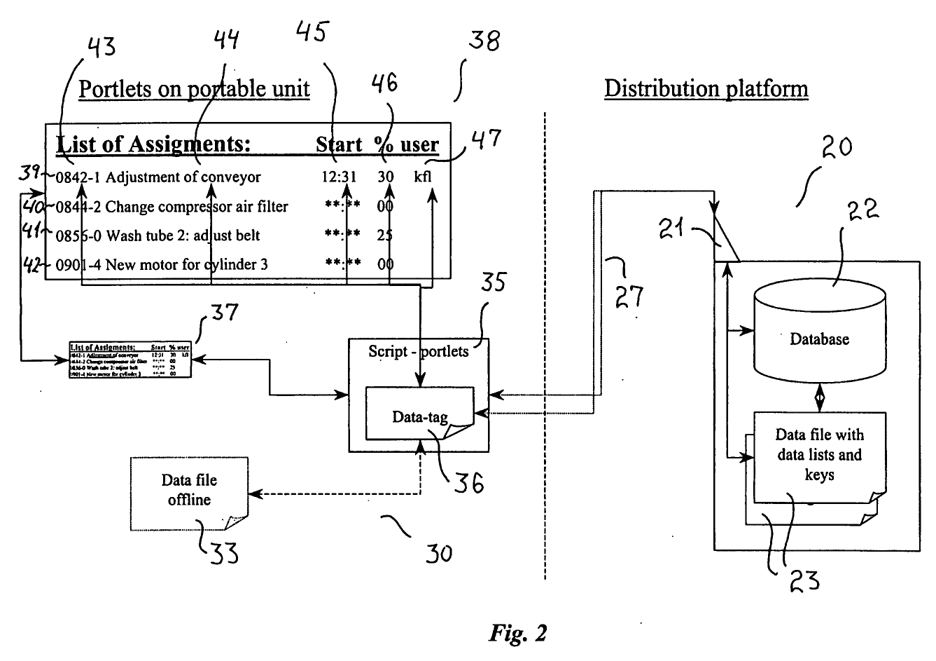

FIG. 2 shows a more detailed view of the script portlet 35 on the portable unit 30 together with the distribution platform 20, comprising the database 22 with data files 23, from which data are communicated to the portable unit 30 by means of the data communication means 21, 27, 31. The transferred data are stored in the data file 33 by an update of the data previously transferred and stored in the data file 33. A part of the content of the data file 33 is, by means of the script portlet 35 and its data tags 36, shown on monitor 37, which is also depicted enlarged 38. Each line 39, 40, 41, 42 on the monitor 37, 38 relates to an awaiting or current job assignment, and comprises a serial number 43, a title 44, an optional starting time 45 and an index of completeness 46 of the assignment, as well as an identification 47 of the human resource to which the job is assigned. A user of the mobile unit 30 may activate the assignment by one single input by touching the touch sensitive screen of the monitor 37, whereby the start time 45 is registered.

The script portlet 25, 35 is a data collection element formed from a script-predefined database object and comprises the data tag elements 26, 36 that are required to interpret the actual data of the data file 23, 33. The actual data may vary depending on the function of the script portlet 35, and it may in addition to the data required to form the lines 39-42 discussed previously, comprise further instructions and information relating to the assignments.

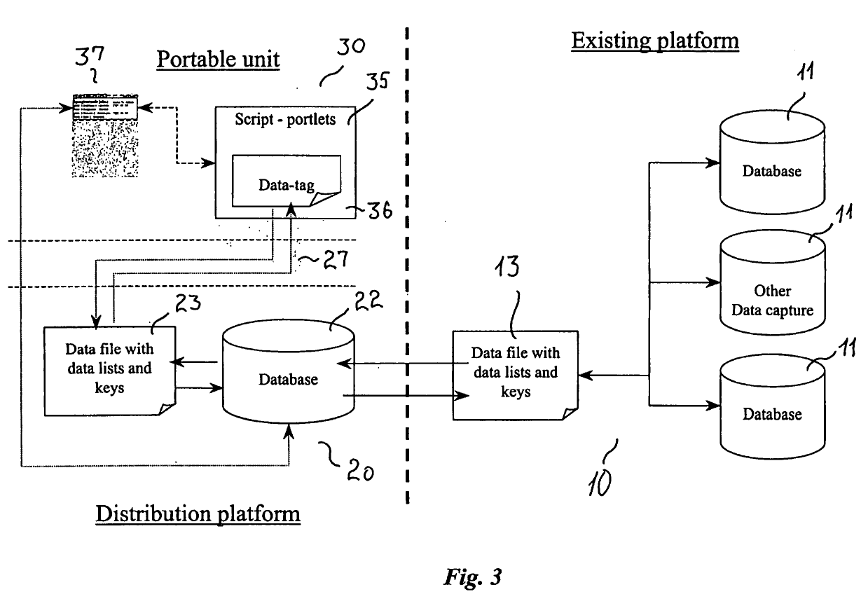

In FIG. 3 is the data flow and the connection and interaction with the existing platform 10 illustrated. Data files 13 comprising data lists and keys are generated at the existing platform 10 and are transmitted to a database 22 of the distribution platform 20, at which another set of data files 23 are generated, comprising data lists and keys. Selected data from the data files 23 are transmitted to the portable units 30 via the wireless data communication connection 27. On the portable unit 30, the script portlet 35 with its data tags 36 associated with the transmitted data can display the data on the monitor screen 37 of the portable unit 30.

When a user by means of the portable unit 30, or when the portable unit as part of an update routine requests data by means of the data tag 36 associated therewith, the data are requested from the local data file 33, which offers the current contents of data to the script portlet 35 and by means of the wireless data communication connection 27 requests updated data from the data files 23 of the distribution system 20, or via data tags of the data files 23 directly from the database 22 of the distribution system 20. The database 22 is regularly updated with data from the existing platform 10 via dedicated data files 13 that are generated for that purpose from the data contained in the databases 11 of various computer platforms constituting the existing platform 10.

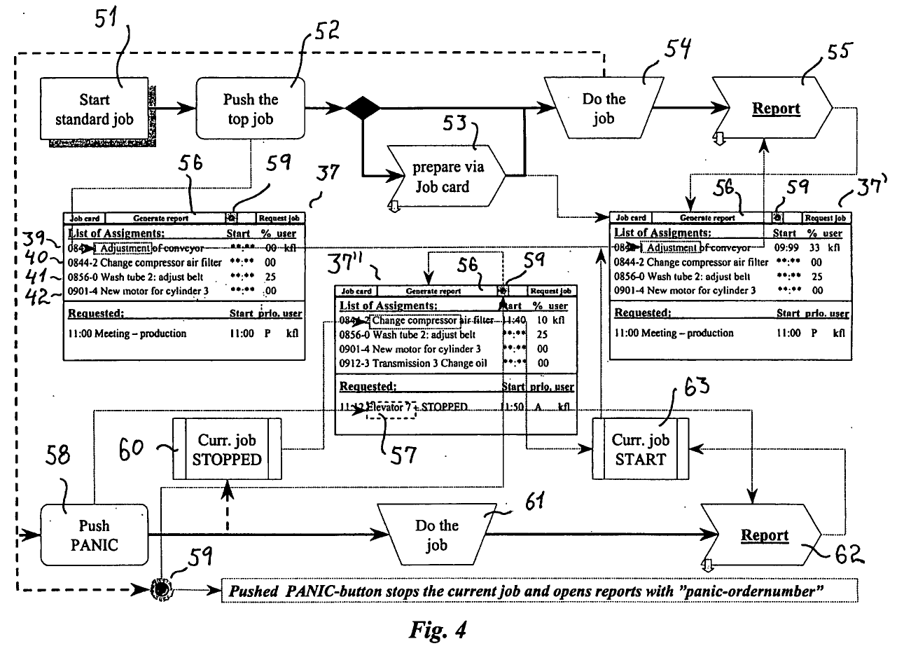

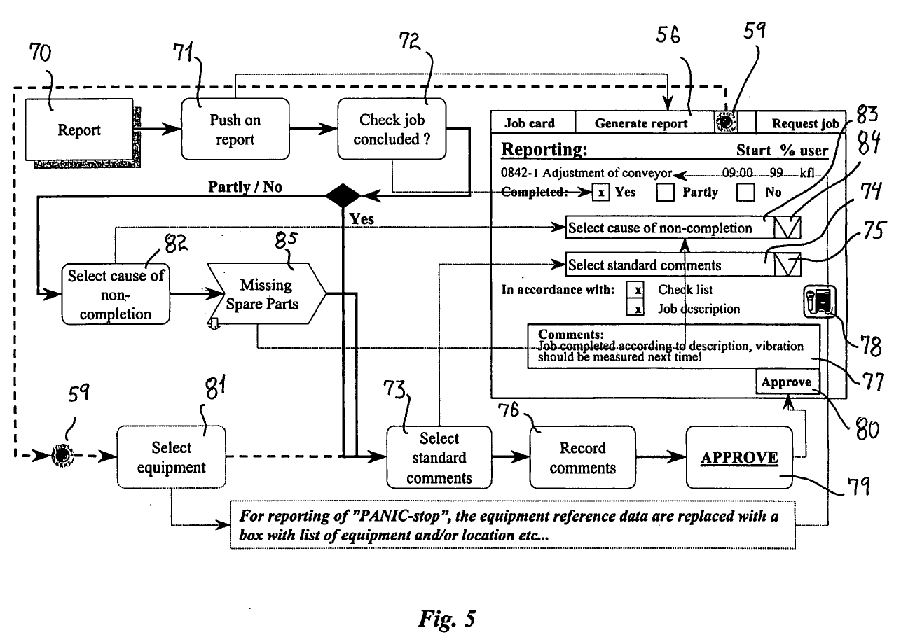

A workflow is illustrated in the flow diagram of FIG. 4, beginning from box 51, in which a standard assigned job is started or activated 52 from the portable terminal 30 by pushing the top job assignment 39 (or alternatively another of the listed job assignments 40-42) on the touch sensitive screen 37 of the portable unit 30. The assigned job may be executed right away 54, or the job card 53 may be consulted by the user by means of the portable unit 30 for obtaining further information by means of a separate data tag 36 linking to data of the data file 33. When the job has been executed or otherwise concluded, a report is generated 55 by input from the user via the screen 37, starting with the activation of the Generate Report area 56, and outcome data are generated and transmitted to the distribution platform 20 by means of the wireless data communication connection 27. The reporting routine is described in details below with reference to FIG. 5. Screen 37 refers to the visual output at the starting of the job assignment, whereas screen 37′ refers to the visual output at the conclusion of the job assignment.

In case a notification 57 of an urgent task is received, as shown on screen 37″, or under other circumstances, at which the user wants to halt or suspend the execution of the current job and execute another job, the current job assignment can be stopped by activating 58 the “Panic” button 59 on the screen 37, which causes the current job to be stopped 60, after which the urgent task can be executed 61 and reported 62 regularly, after which the current job assignment is started again 63 and is executed until reporting 55 the conclusion of the current job. At the activation of the Panic button 59, a notification is transmitted from the portable unit 30 to the distribution system 20. Only urgent tasks, i.e. tasks that are not selected from the list of assignments, can be activated without concluding the previous job assignment with the generation of a report and the generation of the associated outcome data. The general rule is that a job assignment may only be activated 52 when no other job assignment is active, i.e. that the previously active job assignment must have been reported and the associated outcome data generated before a new one is started or activated 52. Thereby, a high rate of outcome data associated with the job assignments is ensured.

When an urgent task or other activity requires the attention of the user of the portable unit 30, a data segment is generated by the distribution system 20, which collects the necessary information from the database 22 for the user to execute the task or activity and transmits the data segment to the portable unit 30 by means of the wireless data communication connection 27. At the portable unit 30, the script portlet 35 interprets the transmitted data segment and displays a notification 57 on the screen 37″. The user may activate the urgent task or activity by pushing the notification 57 on the touch sensitive screen 37″.

In FIG. 5, the generation of a report for a job assignment that has been executed or otherwise concluded is shown. The report generation 70 is initiated at the conclusion 55, 62 of a job assignment or task and the fist step 71 is to push the Generate Report area 56 of the touch sensitive screen 37 of the portable unit 30. A report screen window is displayed on the monitor screen 37 of the portable unit 30 as shown in FIG. 5 and a completion input from the user is requested 72 as a check in one of the three check boxes Yes, Partly and No. In case Yes is selected, the reporting procedure continues by offering the opportunity to add 73 one or more selected comments from a list 74 of standard comments. The list is displayed on the monitor screen 37 of the portable unit 30 by pushing the arrowhead 75 to the right in the standard comments box 74. Hereafter, the user is offered 76 to add further, individual comments to the generated report either as written comments in a dedicated box 77 on the monitor screen 37 or by means of voice recording from a build-in microphone in the portable unit 30, which is activated by pushing the icon 78. Finally, the report is approved 79 by the user by pushing the Approved area 80 of the touch sensitive screen 37.

If an urgent task is to be reported, which has been started by activation of the Panic button 59, i.e. that box 62 from FIG. 4 is the entrance to the report generation procedure 70, the Generate Report area 56 is likewise activated to initiate the procedure, but the Panic button 59 directs the steps of the reporting procedure to a separate box 81 for selection of equipment and/or location on which the urgent task was executed. This is given information in a standard reporting procedure starting from box 55, but the equipment information may or may not have been given in a notification 57. The selection of standard comments 73 from a list 74 is in this procedure replaced with the selection 73 from a standard list 74 of events, which may be supplemented by individual comments 76 in written 77 form or as voice recording 78.

In case the selection 72 of completion input is Partly or No, a selection 82 of one or more causes of non-completion of the assignment must be performed from a predefined standard list 83, which is displayed on the monitor screen 37 of the portable unit 30 by pushing the arrowhead 84 to the right in the box 83 for causes of non-completion. When one cause is selected, presently shown in FIG. 5 is Missing Spare Parts 85, the opportunity of selecting one or more further causes is offered to the user, before the procedure is continued with Selection of Standard Comments, box 73. The one or more selected causes of non-completion are included in the report that is generated, and these outcome data may, combined with similar outcome data from other assignments, be utilised to analyse the efficiency of the workflow that the present system is a tool of. A high rate of data collection with respect to reasons for non-completion of the assignments is thereby ensured, as a report cannot be generated if Partly or No completion is selected, unless at least one of the predefined causes of non-completion is selected, and a new assignment cannot be activated before the previous activated assignment has been reported.

The outcome data are combined with other data in the distribution system and are analysed in an ORE model, parts of which may also be employed to data obtained in other ways than by the system described as an embodiment above. The ORE model is an analytic model of Overall Resource Efficiency, which makes it possible to evaluate and compute the ability of an organisation to utilise the human resources that are available to the organisation. The model has parallels to the OEE model for Overall Equipment Efficiency that was introduced in the 1980'es. The condition for making use of the ORE model is that the rate of data collection is high i.e. at least 80% but preferably much closer to 100%, that the input data are available in a standardised computer-readable form, and that the validity of the input data is high, close to 100%. These conditions can now be fulfilled by systems as the one exemplified by the embodiment and it has therefore been relevant to develop the present ORE model, which in itself may constitute an invention.

The full ORE model comprises three indexes that together represent a measure of the efficiency of an organisation. The indexes are A: Availability, R: resource utilisation, and E: error index, also discussed previously as an actually non-error index.

Availability is defined as the ratio of the full available time, i.e. the nominal working hours, minus the stop time, i.e. the hours spend on other tasks, such as courses, meetings, etc., to the full available time.

Resource utilisation is defined as the ratio between the number of assignments with a completion outcome data and the product of a predefined nominal production and a predefined available time. The predefined nominal time equals A multiplied with the nominal working hours, and the nominal production may either be predefined manually or computed as the inverse of the average time consumption of assignments with a completion outcome data.

The error index is defined and the ratio between the number of assignments with a completion outcome data minus the number of assignments indicated in collected error data, and the number of assignments with a completion outcome data.

The product of the three indexes, A, R and E gives a dimensionless index of the overall efficiency, from which the importance and effect of efficiency improving arrangements may be determined.

1. A system comprising
a central computer having at least one central processing unit and data storage means associated therewith,
a plurality of mobile units having data input means for inputting data from a user of the mobile unit, and means for wireless data communication connection with the central computer,
each mobile unit comprising means to receive data pertaining to assignments from the central computer and transmitting outcome data pertaining to identified assignments to the central computer by means of said data communication connection, and
report generation means adapted to require user input from the data input means of the given mobile unit, indicating selection of
a completion outcome, or
one or more non-completion reasons from a plurality of predefined non-completion reasons,
in order to generate the outcome data, said outcome data comprising information indicating said user input.

2. A system according to claim 1, wherein each mobile unit comprises data output means for outputting data to a user, and wherein said report generation means comprises presenting means for presenting output data representing a plurality of predefined non-completion reasons to the user by means of the data output means of the given mobile unit.

3. A system according to claim 1, wherein the central computer comprises means for transmitting a prioritised list of a plurality of assignments to each mobile unit.

4. A system according to claim 3, wherein each mobile unit comprises means for activation of an assignment from the list of assignments by selecting the assignment by means of the data input means of the mobile unit, and the generation of completion data of an assignment includes terminating the activation of said assignment, the activation of an assignment from the list only being possible if all previous activations of assignments of the mobile unit are terminated.

5. A system according to claim 1, wherein each mobile unit comprises means for registration of resource consumption and the report generation means being adapted to include resource consumption data in the generated outcome data.

6. A system according to claim 5, wherein the resource consumption comprises time consumption.

7. A system according to claim 1, wherein each mobile unit comprises position means for determining current position and generating an output accordingly.

8. A system according to claim 1, further comprising means for determining current position of each mobile unit from a plurality of transceiver stations constituting a wireless data communication network by means of which said wireless data communication connection with the central computer.

9. A system according to claim 1, wherein the central computer comprises means for accumulating the outcome data by storing the outcome data in said data storage means, and means for processing the accumulated outcome data so as to calculate statistical properties thereof.

10. A method of operating a system for distributing assignments and collecting completion data pertaining to the assignments, comprising:
communicating each assignment from a central computer to one of a plurality of mobile units by means of a wireless data communication connection, and
generating outcome data pertaining to an identified assignment after receiving either a user input at the mobile unit indicating selection of a completion outcome, or a user input indicating selection of one or more non-completion reasons from a plurality of predefined non-completion reasons, the outcome data comprising information indicating said user input.

11. A method according to claim 10, wherein a list of predefined non-completion reasons is presented to the user by means of data output means of the mobile unit.

12. A method according to claim 10, further comprising transmitting a prioritized list of a plurality of assignments from the central computer to each of the mobile units.

13. A method according to claim 12, further comprising activating an assignment from the list of assignments of a mobile unit by the data input means of the mobile unit, and
terminating the activation of said assignment concurrent with the generation of completion data of the activated assignment,
wherein the activation of an assignment from the list is only possible if all previous activations of assignments of the mobile unit are terminated.

14. A method according to claim, further comprising
registration of resource consumption data associated with a given assignment, and
including the registered resource consumption data in the generated outcome data generated by means of the report generation means.

15. A method according to claim 14, wherein the resource consumption data comprises time consumption data.

16. A method according to claim 15, wherein the time consumption data are generated from a starting time registered at the activation of the given assignment and an ending time registered at the termination of the activation of the given assignment.

17. A method according to claim 10, further comprising
registration of a current position of a given mobile unit, and
including the registered position data in the generated outcome data generated by the report generation means.

18. A method according to claim 17, wherein the position data are generated at the activation of the given assignment and at the termination of the activation of the given assignment.

19. A computer-based method of quantitative evaluation of resource efficiency for a plurality of human resources attending a plurality of assignments, comprising:
collecting outcome data pertaining to each assignment, wherein each outcome data comprises an indication of either a completion outcome data or of the selection of one or more non-completion reasons from a common predefined list of non-completion reasons,
storing said outcome data in data storage means associated with a computer having a central processing unit,
calculating a total number of assignments with an outcome data and a number of assignments with a completion outcome data,
calculating for each of said predefined non-completion reasons a number of assignments with the specific reason selected, and
storing the calculated numbers in a result file defined in said data storage means.

20. A method according to claim 19, further comprising
calculating a resource utilization index as a ratio between the number of assignments with completion outcome data and a product of a predefined nominal production and a predefined available time, and
storing the calculated resource utilization index in said result file.

21. A computer-based method of quantitative evaluation of resource efficiency for a plurality of human resources attending a plurality of assignments, comprising:
collecting outcome data pertaining to each assignment, wherein each outcome data may comprise an indication of a completion outcome data,
storing said outcome data in data storage means associated with a computer having a central processing unit,
calculating a total number of assignments with an outcome data and a number of assignments with a completion outcome data,
calculating a resource utilization index as a ratio between the number of assignments with a completion outcome data and a product of a predefined nominal production and a predefined available time, and
storing the calculated numbers in a result file defined in said data storage means.

22. A method according to claim 20, wherein predefining the nominal production comprises:
collecting time consumption data pertaining to each assignment,
storing said time consumption data in said data storage means,
calculating the nominal production as an inverse of an average time consumption of assignments with a completion outcome data, and
storing said nominal production in said result file.

23. A method according to claim 19, further comprising generation of an error index including:
collecting error data indicating defective or imperfect condition of identified assignments with a completion outcome data,
storing said error data in said data storage means,
calculating an error index as a ratio between the number of assignments with a completion outcome data minus the number of assignments indicated in the error data, and the number of assignments with a completion outcome, and
storing said error index in said result file.

24. A method according to claim 23, further comprising:
collecting outcome data pertaining to each assignment, wherein each outcome data may comprise an indication of a completion outcome data,
storing said outcome data in data storage means associated with a computer having a central processing unit,
calculating a total number of assignments with an outcome data and a number of assignments with a completion outcome data,
calculating a resource utilization index as a ratio between the number of assignments with a completion outcome data and a product of a predefined nominal production and a predefined available time,
storing the calculated numbers in a result file defined in said data storage means, and
computing an overall resource efficiency index by multiplying the resource utilization index and the error index.

25. A computer program product that, when installed on a computer, may enable the computer to execute the method as defined in claim 19.
